(19) United States
(12) Patent Application Publication
(10) Pub. No.: US 2011/0286717 A1
(43) Pub. Date: Nov. 24, 2011

(54) WIRELESS AUDIO/VIDEO TRANSMISSION SYSTEM, WIRELESS TRANSMISSION DEVICE, AND AUDIO OUTPUT DEVICE AND VIDEO OUTPUT DEVICE

(76) Inventors: Makoto Funabiki, Osaka (JP); Keiichiro Obayashi, Osaka (JP); Koichi Murase, Osaka (JP)

(21) Appl. No.: 13/145,575

(22) PCT Filed: Jan. 28, 2010
(86) PCT No.: PCT/JP2010/000520

§ 371 Date: Jul. 21, 2011

(30) Foreign Application Priority Data
Jan. 29, 2009 (JP) 2009-017550

(51) Int. Cl. H04N 5/765

(52) U.S. Cl. 386/231; 386/E05.002

(57) ABSTRACT

Provided is a wireless video and audio transmission system which is more convenient for a user even when a destination to which video and audio data is transmitted is switched, from a video and audio output device such as a TV, to a video output device such as a liquid-crystal projector.

In the wireless video and audio transmission system (10), one of a video output device (300), a wireless transmission device (100) and an audio output device (400) determines an audio mode of the audio output device (400) by judging whether or not either a video and audio output device (200) or the video output device (300) which is selected to receive a radio signal transmitted from the wireless transmission device (100) and to output video is capable of outputting audio.

### TECHNICAL FIELD

The present invention relates to a wireless video and audio transmission system in which video and audio data is transmitted as a radio signal and video and audio is reproduced, and also relates to devices included in the wireless video and audio transmission system.

### BACKGROUND ART

In recent years, as users wish to have large screens for viewing audio visual data or have home theaters, projectors such as liquid-crystal projectors and DLP projectors have been gradually installed as video display devices in general homes. One of the methods which have been used to transmit video and audio data to such projectors is wireless transmission.

A conventional technology relating to a wireless video and audio transmission system in which video and audio data is transmitted through wireless connection is disclosed in Patent Literature (PTL) 1.

PTL 1 discloses the wireless video and audio transmission system in which a liquid-crystal projector which reproduces video and audio, and a reproducing device such as a DVD player are wirelessly connected. Specifically, a wireless adapter is attached to the DVD player, which is a reproducing device, and to the liquid-crystal projector. The DVD player transmits video and audio data to the liquid-crystal projector wirelessly, and thus a wireless transmission home theater system is provided. It is to be noted that the disclosed system outputs audio from a speaker system connected to the DVD player side.

### CITATION LIST

### Patent Literature

### PTL 1

Japanese Unexamined Patent Application No. 2005-210449

### SUMMARY OF INVENTION

### Technical Problem

However, the conventional wireless video and audio transmission system is sometimes inconvenient for the user in the case where the video and audio data is transmitted, from the video and audio reproducing device such as a DVD player, to a video and audio output device such as a television set (hereinafter referred to as the “TV”) which has a speaker system and to a video output device such as a liquid-crystal projector which does not have a speaker system, and the TV and the liquid-crystal projector are switched to view the audio visual data.

To put it differently, with the conventional wireless video and audio transmission system, now it is assumed that the video and audio data is transmitted from the video and audio reproducing device to the TV, and the TV is outputting the video and audio. Then it is assumed that a destination to which the video and audio data is transmitted is switched from the TV to the liquid-crystal projector. In this case, audio is not outputted because the liquid-crystal projector does not have a speaker system. Thus, the user has to manually change the setting of an amplifier speaker system so that a speaker system, which is separately provided, outputs audio. As described, the conventional wireless video and audio transmission system has a problem causing an inconvenience to the user.

The present invention has been conceived in view of the above described problem, and has an object to provide the wireless video and audio transmission system, a wireless transmission device, an audio output device, and a video output device, which can improve convenience for the user even in the case where the destination to which the video and audio data is transmitted is switched, from the video and audio output device such as the TV, to a video output device such as the liquid-crystal projector.

### Solution to Problem

In order to achieve the above described object, a wireless video and audio transmission system according to an aspect of the present invention is the wireless video and audio transmission system in which video and audio is outputted. The wireless video and audio transmission system includes: a video and audio reproducing device which reproduces and transmits video and audio data; an audio output device which receives the video and audio data from the video and audio reproducing device, transmits either the video and audio data or video data, and either outputs or does not output audio depending on whether an audio mode of the audio output device is an audio output mode or an audio non-output mode; a wireless transmission device which receives either the video and audio data or the video data from either the audio output device or the video and audio reproducing device, and transmits a radio signal which includes the video and audio data, the video data, or audio data; a video and audio output device which receives the radio signal that includes the video and audio data, the video data, or the audio data from the wireless transmission device through wireless connection, and outputs the video and audio data as video and audio, the video data as video, or the audio data as audio; and a video output device which receives the radio signal from the wireless transmission device through wireless connection, and outputs, as video, the video data that is included in the radio signal. In the wireless video and audio transmission system, one of the video output device, the wireless transmission device, and the audio output device determines the audio mode of the audio output device by judging whether or not a connection-destination device is capable of outputting audio. The connection-destination device is either the video and audio output device or the video output device which is selected to receive the radio signal transmitted from the wireless transmission device and to output video.

With the above-described structure, one of the video output device, the wireless transmission device, and the audio output device determines the audio mode of the audio output device by judging whether or not the connection-destination device can output audio. Thus, depending on whether or not the connection-destination device can output audio, the wireless video and audio transmission system can determine the device from which audio is outputted. This means that, even when the destination to which the video and audio data is transmitted is switched from the video and audio output device such as the TV to the video output device such as the liquid-crystal projector, the wireless video and audio transmission system can automatically control audio output. This improves the convenience for the user.

In addition, preferably, the wireless transmission device judges whether or not the connection-destination device is capable of outputting audio, based on wireless-connection-destination device information obtained from the connection-destination device that is wirelessly connected. Then, preferably, the wireless transmission device determines, when it is judged that the connection-destination device is capable of outputting audio, the audio mode of the audio output device to be the same as a previously determined audio mode, and determines, when it is judged that the connection-destination device is not capable of outputting audio, the audio mode of the audio output device to be the audio output mode.

With the above-described structure, the wireless transmission device judges, based on the wireless-connection-destination device information, whether or not the connection-destination device can output audio, and determines the audio mode of the audio output device to be the audio output mode. Thus, the wireless transmission device can cause the audio output device to output audio when the connection-destination device cannot output audio. In other words, the wireless video and audio transmission system can automatically control audio output even when the destination to which the video and audio data is transmitted is switched from the video and audio output device such as the TV to the video output device such as the liquid-crystal projector. This improves the convenience for the user.

Also, the wireless transmission device may further judge whether or not the audio output device is capable of outputting audio, and wirelessly transmit, when it is judged that (i) the audio output device is not capable of outputting audio and (ii) the connection-destination device is not capable of outputting audio, either the audio data or the video and audio data to the video and audio output device so that the video and audio output device outputs audio.

With the above-described structure, the wireless transmission device causes the video and audio output device to output audio by judging whether or not the audio output device can output audio. Thus, the wireless transmission device can determine, depending on whether or not the audio output device can output audio, either to cause the audio output device to output audio or to cause the video and audio output device to output audio. In other words, the wireless video and audio transmission system can automatically control audio output even when the destination to which the video and audio data is transmitted is switched, from the video and audio output device such as the TV, to the video output device such as the liquid-crystal projector. This improves the convenience for the user.

Also, the wireless transmission device may further store a device identifier and audio setting information in association with each other. The device identifier is included in the wireless-connection-destination device information of the connection-destination device. The audio setting information is information for setting an output condition of audio to be outputted from the audio output device. The wireless transmission device may transmit, when the connection-destination device is changed to a different connection-destination device, the audio setting information associated with the different connection-destination device to the audio output device. The audio output device may set, according to the received audio setting information, an output condition of audio to be outputted from the audio output device. Also, preferably, the audio setting information is either sound volume control information for controlling sound volume or sound field control information for controlling a sound field.

With the above-described structure, when the connection-destination device is changed, it is possible to set the output condition of audio to be outputted from the audio output device. In other words, even when the connection-destination device is installed at a different place than where the audio output device is installed, the wireless video and audio transmission system can automatically set the sound volume and the sound field suitable for the view at the place where the connection-destination device is installed. This improves the convenience for the user.

Also, the audio output device may judge whether or not the connection-destination device is capable of outputting audio, based on wireless-connection-destination device information obtained from the connection-destination device that is wirelessly connected via the wireless transmission device. The audio output device may determine, when it is judged that the connection-destination device is capable of outputting audio, the audio mode of the audio output device to be the same as a previously determined audio mode, and determine, when it is judged that the connection-destination device is not capable of outputting audio, the audio mode of the audio output device to be the audio output mode.

With the above-described structure, the audio output device determines the audio mode of the audio output device by judging whether or not the connection-destination device can output audio. In other words, the wireless video and audio transmission system can cause the audio output device to output audio when the connection-destination device cannot output audio. Thus, the wireless video and audio transmission system can automatically control audio output even when the destination to which the video and audio data is transmitted is switched from the video and audio output device such as the TV to the video output device such as the liquid-crystal projector. This improves the convenience for the user.

Also, the video output device may judge, when (i) the video output device itself is selected to be the connection-destination device and (ii) the video output device judges that the video output device itself is not capable of outputting audio; whether or not the audio output device is capable of outputting audio, based on information obtained from the wireless transmission device. The information refers to information about a device connected to the wireless transmission device via a wired communication network. Then, the video output device may determine, when it is judged that the audio output device is capable of outputting audio, the audio mode of the audio output device to be the audio output mode, and instruct the audio output device to output audio.

With the above-described structure, when the connection-destination device is the video output device itself, the video output device determines the audio mode of the audio output device by judging whether or not the video output device itself cannot output audio and whether or not the audio output device can output audio. In other words, when the video output device itself, which is the connection-destination device, cannot output audio, the video output device can cause the audio output device to output audio. In addition, the video output device can determine, depending on whether or not the audio output device can output audio, whether to cause the audio output device to output audio or to cause the video and audio output device to output audio. Thus, the wireless video and audio transmission system can automatically control audio output even when the destination to which the video and audio data is transmitted is switched from the video and audio output device such as the TV to the video output device such as the liquid-crystal projector. This improves the convenience for the user.

It is to be noted that the present invention can be realized not only as a wireless video and audio transmission system but also as a wireless transmission device, an audio output device, and a video output device that are included in the wireless video and audio transmission system. Also, the present invention may be realized as a program causing a computer to execute the processing performed by each processing unit included in the wireless transmission device, the audio output device and the video output device, or as an integrated circuit which achieves processing performed by each processing unit. And it goes without saying that such a program can be distributed through recording media such as a CD-ROM and transmission media such as the Internet.

### Advantageous Effects of Invention

The present invention allows the wireless video and audio transmission system to automatically control audio output even when the wireless-connection-destination device which receives the video and audio data transmitted by the video and audio reproducing device is changed to a different wireless-connection-destination device. This improves the convenience for the user.

### BRIEF DESCRIPTION OF DRAWINGS

FIG. 1 is a block diagram showing an example of a structure of a wireless video and audio transmission system according to Embodiment 1 of the present invention.

FIG. 2 is a block diagram showing a structure of a wireless transmission device according to Embodiment 1 of the present invention.

FIG. 3 is a block diagram showing a structure of a video and audio output device according to Embodiment 1 of the present invention.

FIG. 4 is a block diagram showing a structure of a video output device according to Embodiment 1 of the present invention.

FIG. 5 is a block diagram showing a structure of an audio output device according to Embodiment 1 of the present invention.

FIG. 6 is a block diagram showing, in the wireless video and audio transmission system according to Embodiment 1 of the present invention, a flow of data where a wireless-connection-destination device is the video and audio output device, and the audio output device is in an audio output mode.

FIG. 7 is a block diagram showing, in the wireless video and audio transmission system according to Embodiment 1 of the present invention, a flow of data where the wireless-connection-destination device is the video output device.

FIG. 8 is a flowchart illustrating processing performed by a control unit in the wireless transmission device according to Embodiment 1 of the present invention.

FIG. 9 is a block diagram showing an example of a structure of a wireless video and audio transmission system according to Embodiment 2 of the present invention.

FIG. 10 is a flowchart illustrating processing performed by a control unit in a wireless transmission device according to Embodiment 2 of the present invention.

FIG. 11 is a flowchart illustrating processing performed by a control unit in an audio output device according to Embodiment 3 of the present invention.

FIG. 12 is a flowchart illustrating processing performed by a control unit in a wireless transmission device and a control unit in an audio output device according to Embodiment 4 of the present invention.

FIG. 13 is a flowchart illustrating processing performed by a control unit in a wireless transmission device and a control unit in a video output device according to Embodiment 5 of the present invention.

### DESCRIPTION OF EMBODIMENTS

Following describes embodiments of the present invention with reference to the drawings.

### Embodiment 1

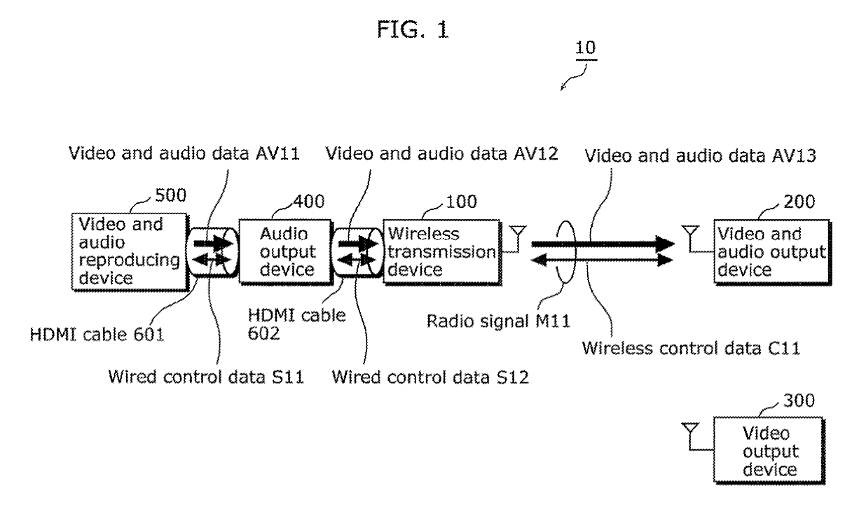

A wireless video and audio transmission system 10 according to Embodiment 1 of the present invention is described with reference to FIG. 1. It is to be noted that FIG. 1 is a block diagram showing an example of a structure of the wireless video and audio transmission system 10 according to Embodiment 1 of the present invention. Also note that FIG. 1 describes an example where a wireless-transmission destination of video and audio data transmitted from the wireless transmission device 100 is not a video output device 300 but a video and audio output device 200.

In FIG. 1, the wireless video and audio transmission system 10 includes the wireless transmission device 100, the video and audio output device 200, the video output device 300, an audio output device 400, a video and audio reproducing device 500, a High-Definition Multimedia Interface (HDMI) cable 601, and an HDMI cable 602.

The video and audio reproducing device 500 reproduces video and audio data, and transmits a wired signal which includes the video and audio data.

The audio output device 400 transmits a wired signal to and receives a wired signal from the wireless transmission device 100 and the video and audio reproducing device 500. When receiving a wired signal from the video and audio reproducing device 500, the audio output device 400 outputs, as audio, the audio data that is included in the wired signal.

Specifically, the audio output device 400 receives the video and audio data from the video and audio reproducing device 500, and transmits either the received video and audio data or video data that is included in the received video and audio data. Furthermore, the audio output device 400 reproduces audio data that is included in the received video and audio data, and either outputs or does not output audio depending on whether an audio mode of the audio output device is an audio output mode or an audio non-output mode.

The wireless transmission device 100 performs conversion between a wired signal and a radio signal, before transmitting a signal or after receiving a signal. Specifically, the wireless transmission device 100 receives either the video and audio data or the video data from either the audio output device 400 or the video and audio reproducing device 500, and transmits a radio signal which includes the video and audio data, the video data, or the audio data.

The video and audio output device 200 transmits radio signal to and receives radio signal from the wireless transmission device 100 through wireless connection. Receiving the radio signal that includes the video and audio data, the video data, or the audio data from the wireless transmission device 100, the video and audio output device 200 processes the data included in the received radio signal and outputs the video and audio data as video and audio, the video data as video, or the audio data as audio.

The video output device 300 transmits radio signal to and receives radio signal from the wireless transmission device 100 through wireless connection, and processes the video data that is included in the radio signal received from the wireless transmission device 100, and outputs the video data as video.

In Embodiment 1, the wireless transmission device 100 determines the audio mode of the audio output device 400 by judging whether or not a connection-destination device can output audio. The connection-destination device is either the video and audio output device 200 or the video output device 300 which is selected to receive the radio signal transmitted from the wireless transmission device 100 and to output video.

Via the HDMI cable 601, the video and audio data AV11 is transmitted from the video and audio reproducing device 500 to the audio output device 400. Also, via the HDMI cable 601, wired control data S11 is communicated between the video and audio reproducing device 500 and the audio output device 400.

Furthermore, via the HDMI cable 602, the video and audio data AV12 is transmitted from the audio output device 400 to the wireless transmission device 100. Also, via the HDMI cable 602, wired control data S12 is communicated between the audio output device 400 and the wireless transmission device 100.

In addition, a radio signal M11 is communicated between the wireless transmission device 100 and the video and audio output device 200 includes: video and audio data AV13 transmitted from the wireless transmission device 100 to the video and audio output device 200; and wireless control data C11 communicated between the wireless transmission device 100 and the video and audio output device 200. Here; for the wireless transmission of the video and audio data AV13 from the wireless transmission device 100 to the video and audio output device 200, either time division multiplexing or frequency division multiplexing is used.

It is to be noted that the video and audio reproducing device 500 is a device which transmits the video and audio data; for example, a DVD recorder, a DVD player, and a set-top box. Also, the video and audio output device 200 is a device which outputs video and audio to a display and a speaker; for example, the TV. Also, the video output device 300 is a device which does not include a speaker system but only outputs video; for example, a monitor, a projector and the like. Also, the audio output device 400 is a device which outputs audio to the speaker system or the like.

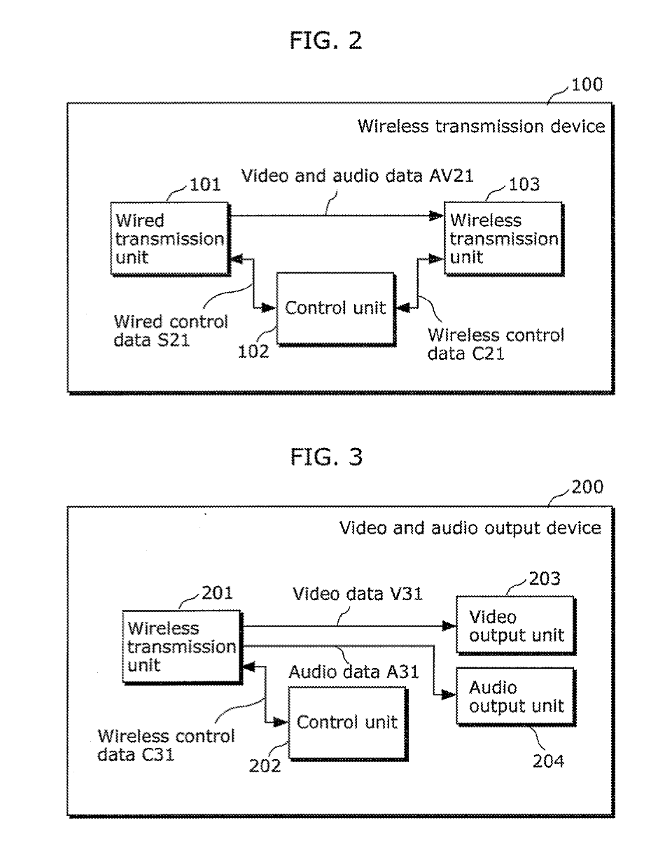

Next, a structure of the wireless transmission device 100 according to Embodiment 1 of the present invention is described with reference to FIG. 2. It is to be noted that FIG. 2 is a block diagram showing a structure of the wireless transmission device 100 according to Embodiment 1 of the present invention.

The wireless transmission device 100 shown in FIG. 2 includes: a wired transmission unit 101 which transmits a signal defined by HDMI standard; a control unit 102 which controls the wired transmission unit 101 and an after-mentioned wireless transmission unit 103; and the wireless transmission unit 103 which performs wireless transmission processing such as transmission, reception, modulation, and demodulation of radio waves, and access control.

The wired transmission unit 101 receives the video and audio data AV12 from the audio output device 400 via the HDMI cable 602, processes the received video and audio data AV12 into video and audio data AV21, and transmits the video and audio data AV21 to the wireless transmission unit 103. The wireless transmission unit 103 processes the video and audio data AV21 received from the wired transmission unit 101, and transmits the processed video and audio data AV21 to the video and audio output device 200 as a radio signal.

The control unit 102 communicates with the wired transmission unit 101 using wired control data S21 in order to check status of and control the wired transmission unit 101. Also, the control unit 102 communicates with the wireless transmission unit 103 using wireless control data C21 in order to check status of and control the wireless transmission unit 103.

The wireless transmission unit 103 includes, for example, an antenna, a radio frequency circuit, and a base band processing circuit, and may adopt any types of wireless transmission methods. Examples of such methods include: wireless transmission method using electric waves in millimeter-wave band; and media access control in which radio-frequency band or time is reserved, and the video and audio data is transmitted and received in the reserved radio-frequency band or time. However, detailed description thereof is omitted here.

Next, a structure of the video and audio output device 200 according to Embodiment 1 of the present invention is described with reference to FIG. 3. It is to be noted that FIG. 3 is a block diagram showing a structure of the video and audio output device 200 according to Embodiment 1 of the present invention.

The video and audio output device 200 shown in FIG. 3 includes: a wireless transmission unit 201 which performs wireless transmission processing such as transmission, reception, modulation, and demodulation of radio waves, and the access control; a control unit 202 which controls the wireless transmission unit 201; a video output unit 203 which receives the video data from the wireless transmission unit 201, processes the video data, and outputs video; and an audio output unit 204 which receives the audio data from the wireless transmission unit 201, processes the received audio data, and outputs audio.

The wireless transmission unit 201 receives the video and audio data AV13 transmitted wirelessly from the wireless transmission device 100, and processes the received video and audio data AV 13 into video data V31 and audio data A31, and transmits the video data V31 to the video output unit 203, and transmits the audio data A31 to the audio output unit 204.

The video output unit 203 receives the video data V31 from the wireless transmission unit 201, processes the received video data V31, and outputs video. The audio output unit 204 receives the audio data A31 from the wireless transmission unit 201, processes the received audio data A31, and outputs audio.

The control unit 202 communicates with the wireless transmission unit 201 using wireless control data C31 in order to check status of and control the wireless transmission unit 201.

The wireless transmission unit 201 includes, for example, an antenna, a radio frequency circuit, and a base band processing circuit, and may adopt any types of wireless transmission methods. Examples of such methods include: wireless transmission method using electric waves in millimeter-wave band; and media access control in which radio-frequency band or time is reserved, and the video and audio data is transmitted and received in the reserved radio-frequency band or time. However, detailed description thereof is omitted here.

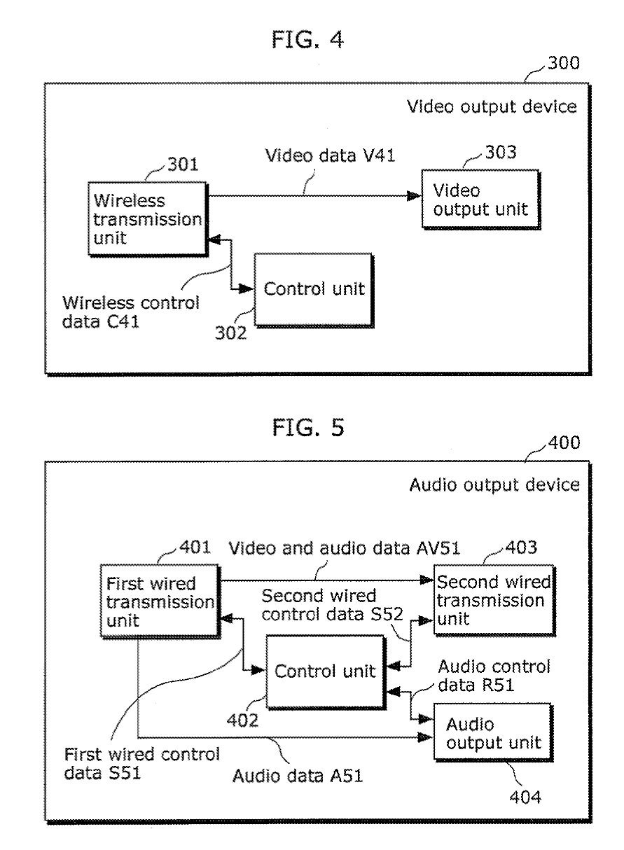

Next, a structure of the video output device 300 according to Embodiment 1 of the present invention is described with reference to FIG. 4. It is to be noted that FIG. 4 is a block diagram showing a structure of the video output device 300 according to Embodiment 1 of the present invention.

The video output device 300 shown in FIG. 4 includes: a wireless transmission unit 301 which performs wireless transmission processing such as transmission, reception, modulation, and demodulation of radio waves, and the access control; a control unit 302 which controls the wireless transmission unit 301; and a video output unit 303 which receives video data V41 from the wireless transmission unit 301, processes the received video data V41, and outputs video.

The wireless transmission unit 301 receives the video and audio data AV13 transmitted wirelessly from the wireless transmission device 100, processes the received video and audio data AV13, and transmits the video data V41 that is included in the video and audio data AV13 to the video output unit 303. The video output unit 303 receives the video data V41 from the wireless transmission unit 301, processes the video data V41, and outputs video. The control unit 302 communicates with the wireless transmission unit 301 using wireless control data C41 in order to check status of and control the wireless transmission unit 301.

The wireless transmission unit 301 includes, for example, an antenna, a radio frequency circuit, and a base band processing circuit, and may adopt any types of wireless transmission methods. Examples of such methods include: wireless transmission method using electric waves in millimeter-wave band; and media access control in which radio-frequency band or time is reserved, and the video and audio data is transmitted and received in the reserved radio-frequency band or time. However, detailed description thereof is omitted here.

Next, a structure of the audio output device 400 according to Embodiment 1 of the present invention is described with reference to FIG. 5. It is to be noted that FIG. 5 is a block diagram showing a structure of the audio output device 400 according to Embodiment 1 of the present invention.

The audio output device 400 shown in FIG. 5 includes: a first wired transmission unit 401 and a second wired transmission unit 403 which transmit a signal defined by the HDMI standard; a control unit 402 which controls the first wired transmission unit 401 and the second wired transmission unit 403; and an audio output unit 404 which receives audio data A51 from the first wired transmission unit 401, processes the received audio data A51, and outputs audio.

The first wired transmission unit 401 receives the video and audio data AV11 transmitted from the video and audio reproducing device 500 via the HDMI cable 601, and processes the received video and audio data AV11 into video and audio data AV51 and audio data A51, and transmits, as a signal defined by the HDMI standard, the video and audio data AV51 to the second wired transmission unit 403, and the audio data A51 to the audio output unit 404.

The second wired transmission unit 403 receives the video and audio data AV51 from the first wired transmission unit 401, processes the received video and audio data AV51 into video and audio data AV12, and transmits the video and audio data AV12 to the wireless transmission device 100 via the HDMI cable 602 as a signal defined by the HDMI standard. The audio output unit 404 receives the audio data A51 from the first wired transmission unit 401, processes the received audio data A51, and outputs audio.

The control unit 402 communicates with the first wired transmission unit 401 using a first wired control data S51 in order to check status of and control the first wired transmission unit 401. The control unit 402 also communicates with the second wired transmission unit 403 using a second wired control data S52 in order to check status of and control the second wired transmission unit 403. In addition, the control unit 402 communicates with the audio output unit 404 using audio control data R51 in order to control the audio output unit 404. Examples of the control include: status check, sound volume control, sound field control, and muting.

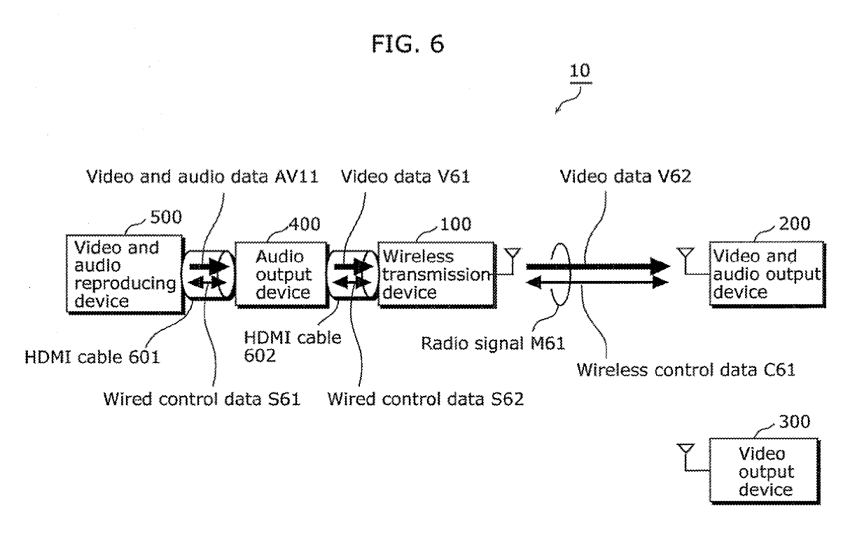

Next, the processing performed by the wireless video and audio transmission system 10 according to Embodiment 1 of the present invention is described with reference to FIG. 1 to FIG. 8, especially with reference to FIG. 6 to FIG. 8.

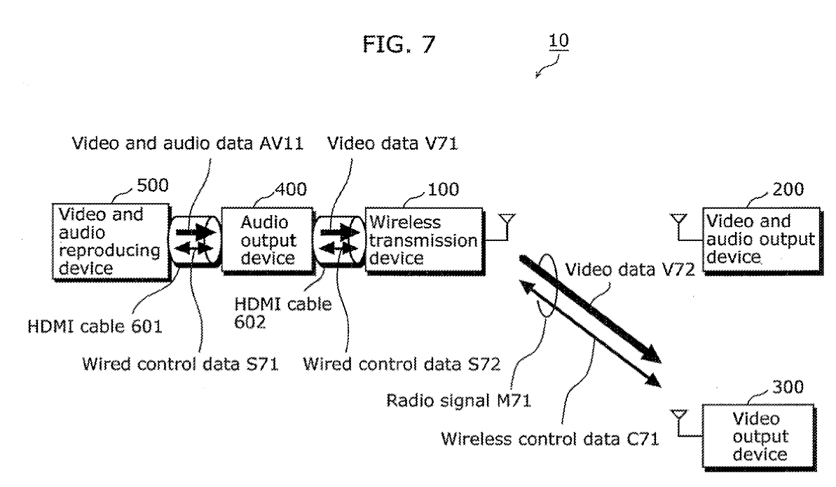

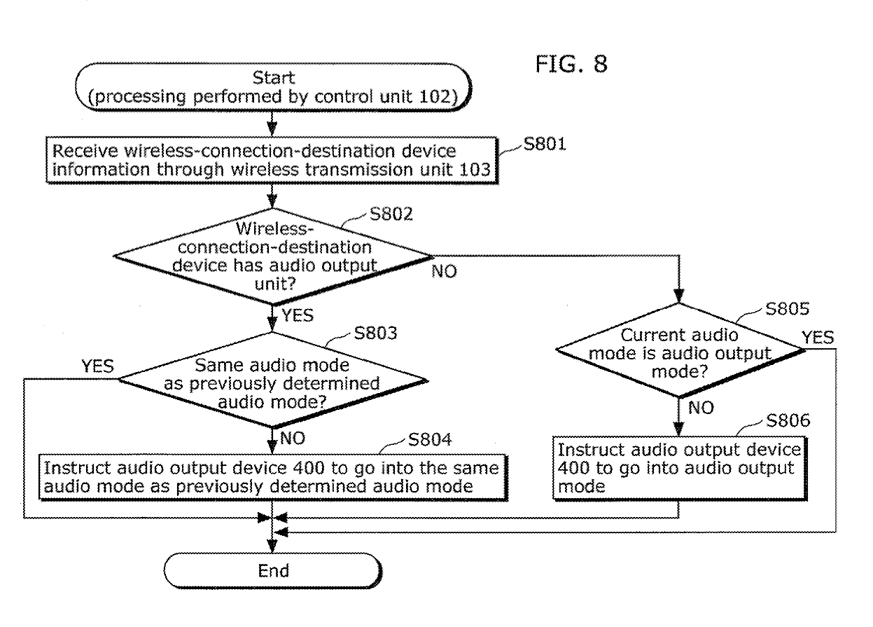

It is to be noted that FIG. 6 is a block diagram showing, in the video and audio transmission system 10 according to Embodiment 1 of the present invention, a flow of data where the wireless-connection-destination device is the video and audio output device 200, and the audio output device is in an audio output mode. Also note that FIG. 7 is a block diagram showing, in the wireless video and audio transmission system 10 according to Embodiment 1 of the present invention, a flow of data where the wireless-connection-destination device is the video output device 300. Also note that FIG. 8 is a flowchart illustrating processing performed by the control unit 102 in the wireless transmission device 100 according to Embodiment 1 of the present invention.

Referring to FIG. 8, first, the control unit 102 receives, through the wireless transmission unit 103, wireless-connection-destination device information either from the video and audio output device 200 shown in FIG. 6 as wireless control data C61 or from the video output device 300 shown in FIG. 7 as wireless control data C71 (S801).

Here, the wireless-connection-destination device is either the video and audio output device 200 or the video output device 300 which is selected to receive the radio signal transmitted from the wireless transmission device 100 and to output video. Also, the wireless-connection-destination device information refers to information about the wireless-connection-destination device. Specifically, the wireless-connection-destination device information includes, for example, a device type of the wireless-connection-destination device, and whether or not the wireless-connection-destination device has a video output unit and an audio output unit. It is to be noted that the term wireless-connection-destination device is equivalent to a “connection-destination device” described in the CLAIMS.

Subsequently, the control unit 102 refers to the received wireless-connection-destination device information, and judges whether or not the wireless-connection-destination device has the audio output unit (S802). For the judgment, the control unit 102 refers to the device type indicated in the wireless-connection-destination device information. When the device type is an AV amplifier or the like, that is a device that can output audio, the control unit 102 judges that the wireless-connection-destination device has the audio output unit. Alternatively, for the judgment, the control unit 102 may refer to, in the wireless-connection-destination device information, the information regarding whether or not the wireless-connection-destination device has the audio output unit.

When the control unit 102 determines, in Step S802, that the wireless-connection-destination device has audio output unit (YES in Step S802), the control unit 102 judges whether or not the current audio mode of the audio output device 400 is the same as a previously determined audio mode (the audio mode before the wireless-connection-destination device is switched to the current wireless-connection-destination device) (S803).

It is to be noted that the audio mode has two modes: an audio output mode, and an audio non-output mode. In the audio output mode, the audio output device 400 outputs audio through the audio output unit 404. In the audio non-output mode, the audio output device 400 does not output audio through the audio output unit 404. Instead, the audio output device 400 transmits, as the video and audio data, the audio data together with the video data through the second wired transmission unit 403.

When the control unit 102 determines, in Step S803, that the current audio mode of the audio output device 400 is the same as the previously determined audio mode (YES in Step S803), the control unit 102 ends the processing.

On the other hand, when the control unit 102 determines, in Step S803, that the current audio mode of the audio output device 400 is different from the previously determined audio mode (No in Step S803), the control unit 102 transmits, through the wired transmission unit 101, control data to the audio output device 400 to instruct the audio output device 400 to go into the same audio mode as the previously determined audio mode (S804).

In addition, when the control unit 102 determines, in Step S802, that the wireless-connection-destination device does not have the audio output unit (No in Step S802), the control unit 102 judges whether or not the current audio mode of the audio output device 400 is the audio output mode (S805).

When it is judged, in Step S805, that the current audio mode of the audio output device 400 is the audio output mode (YES in Step S805), the control unit 102 ends the processing. In addition, when it is judged that the current audio mode of the audio output device 400 is not the audio output mode (No in Step S805), the control unit 102 transmits, through the wired transmission unit 101, control data to the audio output device 400 to instruct the audio output device 400 to go into the audio output mode (S806), and ends the processing.

When the control data which instructs the audio output device 400 to go into the audio non-output mode is received from the wireless transmission device 100, the audio output device 400 transmits, as the video and audio data AV51, the audio data together with the video data to the wireless transmission device 100 through the second wired transmission unit 403. Also, when the control data which instructs the audio output device 400 to go into the audio output mode is received from the wireless transmission device 100, the audio output device 400 reproduces the audio data, and outputs the reproduced audio through the audio output unit 404.

As described, the control unit 102 judges, based on the wireless-connection-destination device information obtained from the wireless-connection-destination device that is wirelessly connected, whether or not the wireless-connection-destination device can output audio. When it is judged that the wireless-connection-destination device can output audio, the control unit 102 determines the audio mode of the audio output device to be the same as the previously determined audio mode, and transmits the video and audio data to the wireless-connection-destination device through the wireless transmission unit 103. When it is judged that the wireless-connection-destination device cannot output audio, the control unit 102 determines the audio mode of the audio output device to be the audio output mode, and transmits either the video data or the video and audio data to the wireless-connection-destination device through the wireless transmission unit 103.

As described above, FIG. 1 describes a flow of the video and audio data AV11, the video and audio data AV12 and the video and audio data AV13, when the wireless-connection-destination device is the video and audio output device 200 and when the audio output device 400 is in the audio non-output mode. In this case, audio is not outputted from the audio output device 400 through the audio output unit 404. Instead, audio is outputted from the video and audio output device 200 which is the wireless-connection-destination device.

FIG. 6 describes a flow of the video and audio data AV11, the video data V61 and the video data V62, when the wireless-connection-destination device is the video and audio output device 200 and when the audio output device 400 is in the audio output mode. In this case, audio is not outputted from the video and audio output device 200 which is the wireless-connection-destination device. Instead, audio is outputted from the audio output device 400 through the audio output unit 404.

FIG. 7 describes a flow of the video and audio data AV11, the video data V71 and the video data V72, when the wireless-connection-destination device is the video output device 300. In this case, the audio mode of the audio output device 400 automatically goes into the audio output mode, and audio is outputted from the audio output device 400 through the audio output unit 404.

As described above, even when the wireless-connection-destination device is switched from the video and audio output device 200 (for example, a TV) to the video output device 300 (for example, a liquid-crystal projector), that is, even when the destination to which the video and audio data is transmitted is switched from the video and audio output device 200 to the video output device 300, audio is outputted from the audio output device 400, which has the speaker system, instead of from the video and audio output device 200, because the wireless video and audio transmission system automatically switches the devices to output audio. This improves the convenience for the user.

### Embodiment 2

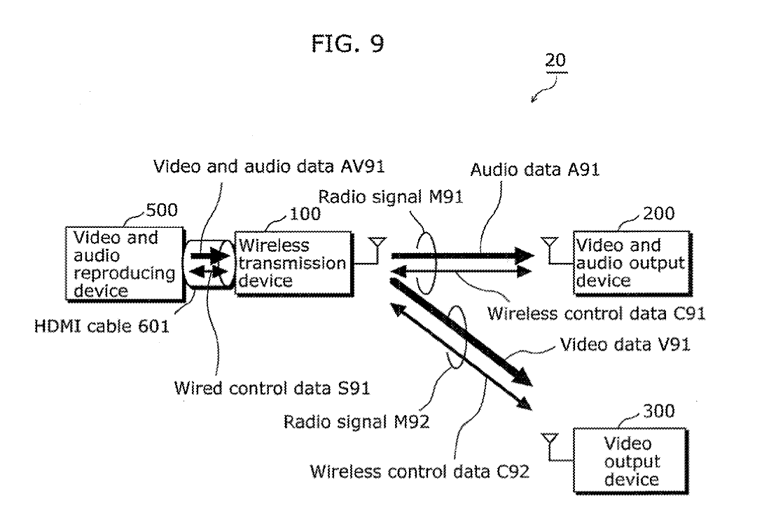

A wireless video and audio transmission system 20 according to Embodiment 2 of the present invention is described with reference to FIG. 9. It is to be noted that FIG. 9 is a block diagram showing an example of a structure of the wireless video and audio transmission system 20 according to Embodiment 2 of the present invention. Also note that Embodiment 2 of the present invention describes a case where a wireless transmission device 100 includes a function for judging whether or not an audio output device 400 is connected (whether the audio output device 400 is present in the wireless video and audio transmission system as shown in FIG. 1).

In FIG. 9, the wireless video and audio transmission system 20 includes: the wireless transmission device 100, a video and audio output device 200, a video output device 300, a video and audio reproducing device 500, and an HDMI cable 601. In other words, the wireless video and audio transmission system 20 according to Embodiment 2 is, except for the absence of the audio output device 400 and the HDMI cable 602, the same as the wireless video and audio transmission system 10 according to Embodiment 1. It is to be noted that, each of the similar components, as in the wireless video and audio transmission system 10 according to Embodiment 1 of the present invention shown in FIG. 1, is denoted by the same reference sign, and the detailed description thereof is omitted.

Here, the video and audio reproducing device 500 is a device which transmits video and audio data; for example, a DVD recorder, a DVD player, and a set-top box. The video and audio output device 200 is a device which outputs video and audio to a display and a speaker system; for example, a TV. The video output device 300 is a device which does not have the speaker system but only outputs video; for example, a TV monitor, and a liquid-crystal projector.

Via the HDMI cable 601, video and audio data AV91 is transmitted from the video and audio reproducing device 500 to the wireless transmission device 100. Also, via the HDMI cable 601, wired control data S91 is communicated between the video and audio reproducing device 500 and the wireless transmission device 100.

A radio signal M91 communicated between the wireless transmission device 100 and the video and audio output device 200 is made up of audio data A91 and wireless control data C91. A radio signal M92 communicated between the wireless transmission device 100 and the video output device 300 is made up of video data V91 and wireless control data C92.

The wireless transmission device 100 and the video and audio output device 200 are connected wirelessly. The wireless transmission device 100 and the video output device 300 are also connected wirelessly. For both the transmission of the audio data A91, from the wireless transmission device 100 to the video and audio output device 200, and the transmission of the video data V91, from the wireless transmission device 100 to the video output device 300, either time division multiplexing or frequency division multiplexing is used.

The control unit 102 in the wireless transmission device 100 includes, in addition to the functions included in the control unit 102 in the wireless video and audio transmission system 10 according to Embodiment 1, the function for judging whether or not the audio output device 400 is connected in the wireless video and audio transmission system.

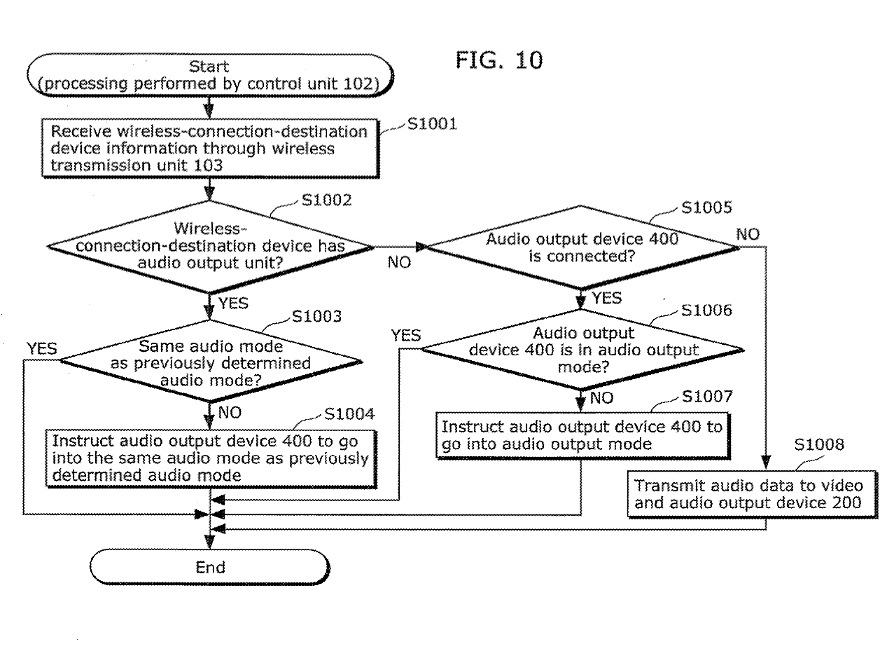

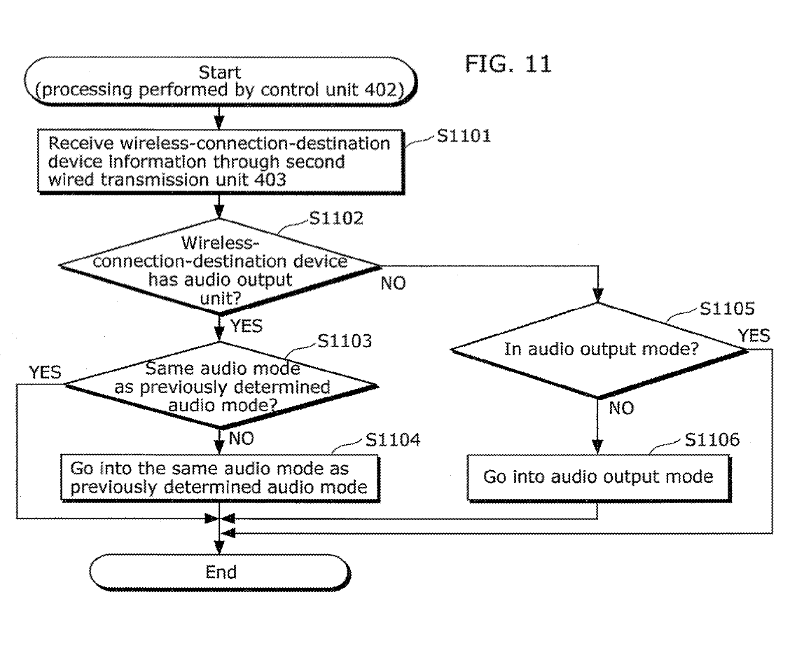

Next, referring to FIG. 10, processing performed by the control unit 102 in the wireless transmission device 100 according to Embodiment 2 of the present invention is described. It is to be noted that FIG. 10 is a flowchart illustrating processing performed by the control unit 102 in the wireless transmission device 100 according to Embodiment 2 of the present invention.

The wireless video and audio transmission system 20 shown in FIG. 9 shows an example where the audio output device 400 is not connected between the wireless transmission device 100 and the video and audio reproducing device 500. However, following describes the processing performed when the wireless video and audio transmission system includes the audio output device 400 (connected) as shown in FIG. 1, as well as the processing performed when the wireless video and audio transmission system does not include the audio output device 400 (not connected) as shown in FIG. 9.

Referring to FIG. 10, first, when the wireless transmission device 100 is connected to either the video and audio output device 200 or the video output device 300 through wireless connection, the control unit 102 receives wireless-connection-destination device information through the wireless transmission unit 103 (S1001). The wireless-connection-destination device information includes, for example, a device type of the wireless-connection-destination device, and whether or not the wireless-connection-destination device has a video output unit and an audio output unit.

Subsequently, the control unit 102 refers to the wireless-connection-destination device information received from the wireless transmission unit 103, and judges whether or not the wireless-connection-destination device has the audio output unit (S1002). For the judgment, the control unit 102 refers to the device type indicated in the wireless-connection-destination device information. When the device type is an AV amplifier or the like, that is a device that can output audio, the control unit 102 judges that the wireless-connection-destination device has the audio output unit. Alternatively, for the judgment, the control unit 102 may refer to, in the wireless-connection-destination device information, the information regarding whether or not the wireless-connection-destination device has the audio output unit.

When it is judged, in Step S1002, that the wireless-connection-destination device has the audio output unit (YES in Step S1002), the control unit 102 judges whether or not the current audio mode of the audio output device 400 is the same as the previously determined audio mode (the audio mode before the wireless-connection-destination device is switched to the current wireless-connection-destination device) (S1003).

It is to be noted that the audio mode has two modes: an audio output mode, and an audio non-output mode. In the audio output mode, the audio output device 400 outputs the audio through the audio output unit 404. In the audio non-output mode, the audio output device 400 does not output audio through the audio output unit 404. Instead, the audio output device 400 transmits, as the video and audio data AV92 (not shown), the audio data together with the video data through the second wired transmission unit 403.

When it is judged, in Step S1003, that the current audio mode of the audio output device 400 is the same as the previously determined audio mode (YES in Step S1003), the control unit 102 ends the processing.

In addition, when it is judged that the current audio mode of the audio output device 400 is different from the previously determined audio mode (No in Step S1003), the control unit 102 transmits, through the wired transmission unit 101, control data to the audio output device 400 via the HDMI cable 602 to instruct the audio output device 400 to go into the same audio mode as the previously determined audio mode (S1004).

It is to be noted that the control unit 102 may also judge whether or not the audio output device 400 is connected (whether the audio output device 400 is present in the wireless video and audio transmission system) such that the determination of the audio mode (S1003) and the instruction to go into the same audio mode as the previously determined audio mode (S1004) are skipped when it is judged that the audio output device 400 is not connected.

Also, when it is judged, in Step S1002, that the wireless-connection-destination device does not have the audio output unit (No in Step S1002), the control unit 102 judges whether or not the audio output device 400 is connected (whether the audio output device 400 is present in the wireless video and audio transmission system) (S1005).

When it is judged, in Step S1005, that the audio output device 400 is not connected (No in Step S1005), the control unit 102 transmits the audio data A91 to the video and audio output device 200 through the wireless transmission unit 103 (S1008), and ends the processing.

As described, the control unit 102 judges whether or not the audio output device 400 can output audio, and when it is judged that the audio output device 400 cannot output audio and judged that the connection-destination device cannot output audio, the control unit 102 wirelessly transmits either the audio data or the video and audio data to the video and audio output device 200 so that the video and audio output device 200 outputs audio.

When it is judged that the audio output device 400 is connected (YES in Step S1005), the control unit 102 judges whether or not the current audio mode of the audio output device 400 is the audio output mode (S1006).

When it is judged, in Step S1006, that the current audio mode of the audio output device 400 is the audio output mode (YES in Step S1006), the control unit 102 ends the processing.

In addition, when it is judged that the current audio mode is not the audio output mode (No in Step S1006), the control unit 102 transmits, through the wired transmission unit 101, the control data to the audio output device 400 via the HDMI cable 602 to instruct the audio output device 400 to go into the audio output mode.

When receiving, from the wireless transmission device 100, the control data which instructs the audio output device 400 to go into the audio non-output mode, the audio output device 400 transmits the audio data to the wireless transmission device 100 through the second wired transmission unit 403. Also, when receiving, from the wireless transmission device 100, the control data which instructs the audio output device 400 to go into the audio output mode, the audio output device 400 outputs the reproduced audio through the audio output unit 404.

FIG. 9 describes a flow of the video and audio data AV91, the video data V91 and the audio data A91 when the wireless-connection-destination device is the video output device 300 and when the audio output device 400 is not connected. In this case, the video and audio output device 200 outputs audio through the audio output unit 204.

It is to be noted that, although it has been explained that the radio signal M91 is made up of the audio data A91 and the wireless control data C91, the radio signal M91 may include the video and audio data AV91 (not shown) and the wireless control data C91. Likewise, although it has been explained that the radio signal M92 is made up of the video data V91 and the wireless control data C92, the radio signal M92 may include the video and audio data AV91 and wireless control data C92.

As described above, even when the wireless-connection-destination device is switched from the video and audio output device 200 (for example, the TV) to the video output device 300 (for example, the liquid-crystal projector), that is, even when the destination to which the video and audio data is transmitted is switched from the video and audio output device 200 to the video output device 300, audio is outputted from the audio output device 400, which has the speaker system, instead of from the video and audio output device 200, because the wireless video and audio transmission system automatically switches the devices to output audio. This improves the convenience for the user. Furthermore, even when the wireless video and audio transmission system does not include the audio output device 400 (not connected), the wireless video and audio transmission system automatically causes the video and audio output device 200, which has the speaker system, to output audio. This further improves the convenience for the user.

### Embodiment 3

Referring to FIG. 11, processing performed by a control unit 402 in an audio output device 400 according to Embodiment 3 of the present invention is described. It is to be noted that FIG. 11 is a flowchart illustrating processing performed by the control unit 402 in the audio output device 400 according to Embodiment 3 of the present invention. It is to be noted that a structure of a wireless video and audio transmission system according to Embodiment 3 of the present invention is similar to the wireless video and audio transmission system 10 shown in FIG. 1, and thus each of the components is denoted by the same reference sign as shown in FIG. 1.

According to Embodiment 3 of the present invention, the control unit 402 in the audio output device 400 performs, instead of the control unit 102 in the wireless transmission device 100 according to Embodiment 1 of the present invention, major functions relating to the control of the present invention in the wireless video and audio transmission system.

Referring to FIG. 11, first, when a wireless transmission device 100 is connected to either a video and audio output device 200 or a video output device 300 through wireless connection, the control unit 402 receives, from the wireless transmission device 100 through a second wired transmission unit 403, wireless-connection destination device information which has been transmitted to the wireless transmission device 100 from either the video and audio output device 200 or the video output device 300 (S1101). It is to be noted that, the wireless-connection-destination device information includes, for example, Extended Display Identification Data (EDID) information and a device type of the wireless-connection-destination device, and whether or not the wireless-connection-destination device has a video output unit and an audio output unit.

Next, the control unit 402 refers to the wireless-connection-destination device information received from the wireless transmission device 100 through the second wired transmission unit 403, and judges whether or not the wireless-connection-destination device has the audio output unit (S1102). Here, when the EDID information is received, the control unit 402 judges that the wireless-connection-destination device does not have the audio output unit, when information on supported audio format is not included in the received EDID information; and the control unit 402 judges that the wireless-connection-destination device has the audio output unit, when information on supported audio format is included.

When it is judged, in Step S1102, that the wireless-connection-destination device has the audio output unit (YES in Step S1102), the control unit 402 judges whether or not the current audio mode of the audio output device 400 is the same as a previously determined audio mode (the audio mode before the wireless-connection-destination device is switched to the current wireless-connection-destination device) (S1103).

It is to be noted that the audio mode has two modes: an audio output mode, and an audio non-output mode. In the audio output mode, the audio output device 400 outputs reproduced audio through the audio output unit 404. In the audio non-output mode, the audio output device 400 does not output audio through the audio output unit 404. Instead, the audio output device 400 transmits, as the video and audio data AV12, the audio data together with the video data to the wireless transmission device 100 through the second wired transmission unit 403.

When it is judged, in Step S1103, that the current audio mode of the audio output device 400 is the same as the previously determined audio mode (YES in Step S1103), the control unit 402 ends the processing.

When it is judged that the current audio mode of the audio output device 400 is different from the previously determined audio mode (No in Step S1103), the control unit 402 causes the audio output device 400 to go into the same audio mode as the previously determined audio mode (S1104).

In addition, when it is judged, in Step S1102, that the wireless-connection-destination device does not have the audio output unit (No in Step S1102), the control unit 402 judges whether or not the current audio mode of the audio output device 400 is the audio output mode (S1105).

When it is judged, in Step S1105, that the current audio mode of the audio output device 400 is the audio output mode (YES in Step S1105), the control unit 402 ends the processing.

When it is judged that the current audio mode of the audio output device 400 is not the audio output mode (No in Step S1105), the control unit 402 causes the audio output device 400 to go into the audio output mode (S1106), and ends the processing.

As described, the control unit 402 in the audio output device 400 judges whether or not the wireless-connection-destination device can output audio, based on the wireless-connection-destination device information obtained from the wireless-connection-destination device that is wirelessly connected via the wireless transmission device 100. When it is judged that the wireless-connection-destination device can output audio, the control unit 402 determines the audio mode of the audio output device 400 to be the same as the previously determined audio mode. When it is judged that the wireless-connection-destination device cannot output audio, the control unit 402 determines the audio mode of the audio output device 400 to be the audio output mode.

As described above, even when the wireless-connection-destination device is switched from the video and audio output device 200 (for example, a TV) to the video output device 300 (for example, a liquid-crystal projector), that is, even when the destination to which the video and audio data is transmitted is switched from the video and audio output device 200 to the video output device 300, audio is outputted from the audio output device 400, which has the speaker system, instead of from the video and audio output device 200, because the wireless video and audio transmission system automatically switches the devices to output audio. This improves the convenience for the user.

### Embodiment 4

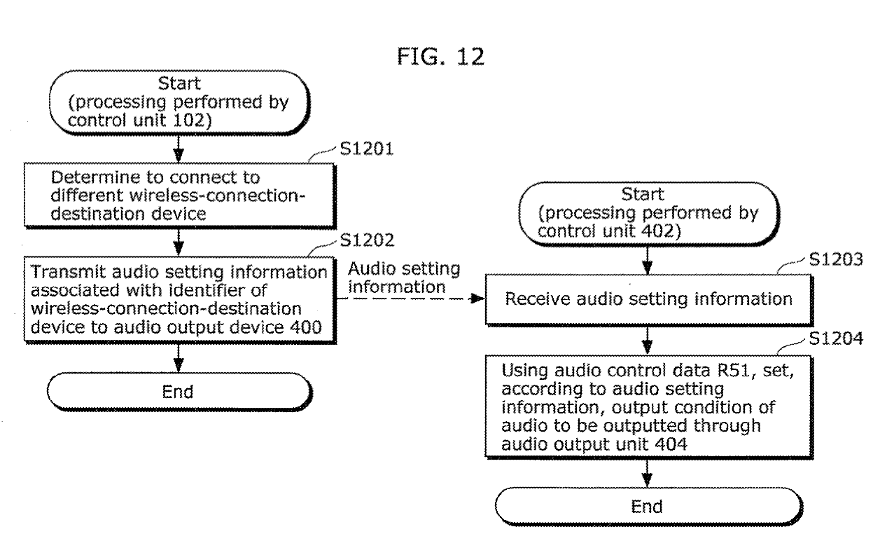

Referring to FIG. 12, processing performed by a control unit 102 in a wireless transmission device 100 and a control unit 402 in an audio output device 400 according to Embodiment 4 of the present invention is described. It is to be noted that FIG. 12 is a flowchart illustrating processing performed by the control unit 102 in the wireless transmission device 100 and the control unit 402 in the audio output device 400 according to Embodiment 4 of the present invention. It is to be noted that a structure of a wireless video and audio transmission system according to Embodiment 4 of the present invention is similar to the wireless video and audio transmission system 10 shown in FIG. 1, and thus each of the components is denoted by the same reference sign as shown in FIG. 1.

First, the control unit 102 determines to connect to a different wireless-connection-destination device (S1201), and transmits, through the wired transmission unit 101 via the HDMI cable 602, audio setting information which is associated with an identifier of the different wireless-connection-destination device to the audio output device 400 (S1202). It is to be noted that the identifier of the wireless-connection-destination device is included in the wireless-connection-destination device information. Also, note that the audio setting information is information for setting an output condition of audio to be outputted through the audio output unit 404.

The control unit 402 in the audio output device 400 receives, through the second wired transmission unit 403, the audio setting information transmitted from the wireless transmission device 100 (S1203). Then, using audio control data R51, the control unit 402 sets, according to the audio setting information received from the wireless transmission device 100, the output condition of audio to be outputted through the audio output unit 404, and ends the processing (S1204).

As described, the control unit 102 in the wireless transmission device 100 stores the device identifier and the audio setting information in association with each other. The device identifier is included in the wireless-connection-destination device information of the connection-destination device. The audio setting information is information for setting an output condition of audio to be outputted from the audio output device 400. The control unit 102 transmits, when the connection-destination device is changed to a different connection-destination device, the audio setting information associated with the different connection-destination device to the audio output device 400. Then the control unit 402 in the audio output device 400 sets, according to the received audio setting information, an output condition of audio to be outputted.

Regarding the setting of the audio output condition, for example, when the wireless-connection-destination device is installed at a different place than where the audio output device 400 is installed, following is possible. For example, it is possible to use, as audio output information, information for controlling the sound field of the audio output device 400 to set a sound field suitable for viewing at the place where the wireless-connection-destination device is installed. It is also possible to use, as audio output information, information for controlling the sound volume of the audio output device 400 to set appropriate sound volume suitable for viewing at the place where the wireless-connection-destination device is installed.

Furthermore, the identifier of the wireless-connection-destination device that is included in the wireless-connection-destination device information and the audio setting information is associated as follows. When the wireless transmission device 100 is connected to the wireless-connection-destination device and obtains the wireless-connection-destination device information, and when the user set the audio setting information by using an audio setting information setting unit (not shown) in the wireless transmission device 100, the control unit 102 stores, in a memory (not shown), the identifier of the wireless-connection-destination device and the audio setting information in association with each other.

As described, by storing the identifier of the wireless-connection-destination device and the audio setting information in association with each other, for example, it is possible to automatically set the sound volume and the sound field that are suitable for viewing at a place where the wireless-connection-destination device is installed, even when the wireless-connection-destination device is installed at a different place than where the audio output device is installed.

### Embodiment 5

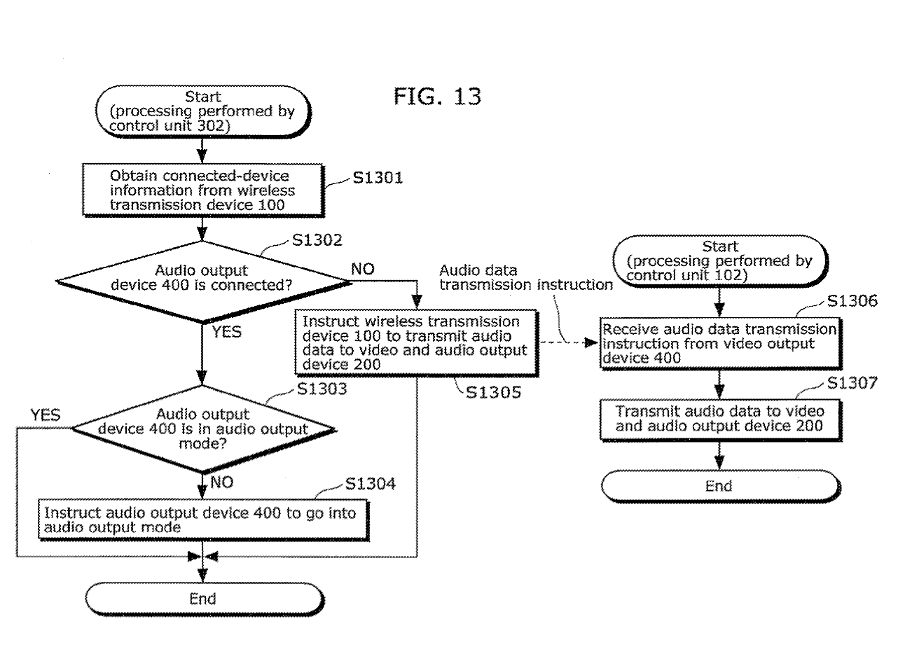

Referring to FIG. 13, processing performed by a control unit 102 in a wireless transmission device 100 and a control unit 302 in an audio output device 300 according to Embodiment 5 of the present invention is described. It is to be noted that FIG. 13 is a flowchart illustrating processing performed by the control unit 102 in the wireless transmission device 100 and the control unit 302 in the audio output device 300 according to Embodiment 5 of the present invention. It is to be noted that a structure of a wireless video and audio transmission system according to Embodiment 5 of the present invention is similar to the wireless video and audio transmission system 10 shown in FIG. 7, and thus each of the components is denoted by the same reference sign as shown in FIG. 7.

First, the control unit 302 in the video output device 300 detects that the destination of the video data transmitted from the wireless transmission device 100 is changed to the video output device 300 itself, and obtains connected-device information from the wireless transmission device 100 (S1301). It is to be noted that the control unit 302 may obtain the connected-device information from the wireless transmission device 100 prior to the detection of the switching of the destination of the transmission of the video data.

Here, the connected-device information includes information indicating a device type of a device that is connected to the wireless transmission device 100 via an HDMI cable 602 and an HDMI cable 601. For example, the wireless transmission device 100 identifies the device type by referring to a logical address of an HDMI-CEC of a device that is connected to the wireless transmission device 100 via the HDMI cable 602 and the HDMI cable 601, and transmits the identified device type to the video output device 300. Alternatively, the wireless transmission device 100 may transmit a list, which includes logical addresses of devices connected to the wireless transmission device 100 via the HDMI cable 602 and the HDMI cable 601, to the video output device 300. Thus, the control unit 302 can obtain the connected-device information from the wireless transmission device 100.

Then the control unit 302 refers to the connected-device information obtained from the wireless transmission device 100, and judges whether or not the audio output device 400 is connected (S1302).

When it is judged that the audio output device 400 is connected (YES in Step S1302), the control unit 302 judges whether or not the audio output device 400 is in the audio output mode (S1303). When it is judged that the audio output device 400 is in the audio output mode (YES in Step S1303), the control unit 302 ends the processing.

In addition, when it is judged that the audio output device 400 is in the audio non-output mode (No in Step S1303), the control unit 302 instructs, through the wireless transmission device 100, the audio output device 400 to go into the audio output mode (S1304).

When the control data which instructs the audio output device 400 to go into the audio non-output mode is received from the video output device 300, the audio output device 400 transmits the audio data to the wireless transmission device 100 through the second wired transmission unit 403. When the control data which instructs the audio output device 400 to go into the audio output mode is received from the video output device 300, the audio output device 400 outputs the reproduced audio through the audio output unit 404.

Furthermore, when it is judged that the audio output device 400 is not connected (No in Step S1302), the control unit 302 transmits, to the wireless transmission device 100, an audio data transmission instruction, which is for instructing the wireless transmission device 100 to transmit the audio data to the video and audio output device 200 (S1305).

The control unit 102 in the wireless transmission device 100 receives the audio data transmission instruction from the video output device 300 (S1306), and transmits the audio data to the video and audio output device 200 (S1307).

As described, the control unit 302 in the video output device 300 judges, when the video output device 300 itself is selected to be the wireless-connection-destination device and judges that the video output device 300 itself cannot output audio, whether or not the audio output device 400 can output audio, based on the information obtained from the wireless transmission device 100. The information refers to information about a device connected to the wireless transmission device 100 via a wired communication network. And when it is judged that the audio output device 400 can output audio, the control unit 302 determines the audio mode of the audio output device 400 to be the audio output mode, and instructs the audio output device 400 to output audio.

As described above, even when the wireless-connection-destination device is switched from the video and audio output device 200 (for example, a TV) to the video output device 300 (for example, a liquid-crystal projector), that is, even when the destination to which the video and audio data is transmitted is switched from the video and audio output device 200 to the video output device 300, audio is outputted from the audio output device 400, which has the speaker system, instead of from the video and audio output device 200, because the wireless video and audio transmission system automatically switches the devices to output audio. This improves the convenience for the user. Furthermore, even when the wireless video and audio transmission system does not include the audio output device 400 (not connected), the wireless video and audio transmission system automatically causes the video and audio output device 200, which has the speaker system, to output audio. This further improves the convenience for the user.

It is to be noted that a packet format and a table format described in Embodiments 1 to 5 are examples, and different format may be used as long as similar effect is achieved.

Also note that the system structure and the device structure described in Embodiments 1 to 5 are examples, and thus the present invention should not be limited to the examples in the embodiments. In other words, various changes and modifications can be made to the specific structure of the present invention within the scope of the present invention. It should be understood that each of the components included in the above described embodiments may be used in any combination within the scope of the present invention.

For example, although each device shown in FIG. 2 to FIG. 4 includes wireless transmission unit, a structure without a wireless transmission unit may also be adopted. Instead of a wireless transmission unit, each device may include a wired transmission unit to which an adaptor for converting wired connection to wireless connection is attached.

### INDUSTRIAL APPLICABILITY

The wireless video and audio transmission system, the wireless transmission device, the audio output device and the video output device according to the present invention are useful for a wireless video and audio transmission system such as a wireless theater in which, as a destination of video and audio data, a video and audio output device such as a TV with a speaker system and a video output device such as a liquid-crystal projector without a speaker system are included and switched while viewing audio visual data, and are also useful for devices included in the wireless video and audio transmission system.

### REFERENCE SIGNS LIST

10, 20 Wireless video and audio transmission system
100 Wireless transmission device
101 Wired transmission unit
102 Control unit
103 Wireless transmission unit
200 Video and audio output device
201 Wireless transmission unit
202 Control unit
203 Video output unit
204 Audio output unit
300 Video output device
301 Wireless transmission unit
302 Control unit
303 Video output unit
400 Audio output device
401 First wired transmission unit
402 Control unit
403 Second wired transmission unit
404 Audio output unit
500 Video and audio reproducing device
601 HDMI cable
602 HDMI cable

1. A wireless video and audio transmission system in which video and audio is outputted, said wireless video and audio transmission system comprising:
a video and audio reproducing device which reproduces and transmits video and audio data;
an audio output device which receives the video and audio data from said video and audio reproducing device, transmits either the video and audio data or video data, and either outputs or does not output audio depending on whether an audio mode of said audio output device is an audio output mode or an audio non-output mode;
a wireless transmission device which receives either the video and audio data or the video data from either said audio output device or said video and audio reproducing device, and transmits a radio signal which includes the video and audio data, the video data, or audio data;
a video and audio output device which receives the radio signal that includes the video and audio data, the video data, or the audio data from said wireless transmission device through wireless connection, and outputs the video and audio data as video and audio, the video data as video, or the audio data as audio; and
a video output device which receives the radio signal from said wireless transmission device through wireless connection, and outputs, as video, the video data that is included in the radio signal,
wherein one of said video output device, said wireless transmission device, and said audio output device determines the audio mode of said audio output device by judging whether or not a connection-destination device is capable of outputting audio, the connection-destination device being either said video and audio output device or said video output device which is selected to receive the radio signal transmitted from said wireless transmission device and to output video.

2. The wireless video and audio transmission system according to claim 1,
wherein said wireless transmission device:
judges whether or not the connection-destination device is capable of outputting audio, based on wireless-connection-destination device information obtained from the connection-destination device that is wirelessly connected;
determines, when it is judged that the connection-destination device is capable of outputting audio, the audio mode of said audio output device to be the same as a previously determined audio mode; and
determines, when it is judged that the connection-destination device is not capable of outputting audio, the audio mode of said audio output device to be the audio output mode.

3. The wireless video and audio transmission system according to claim 2,
wherein said wireless transmission device further: judges whether or not said audio output device is capable of outputting audio; and wirelessly transmits, when it is judged that (i) said audio output device is not capable of outputting audio and (ii) the connection-destination device is not capable of outputting audio, either the audio data or the video and audio data to said video and audio output device so that said video and audio output device outputs audio.

4. The wireless video and audio transmission system according to claim 2,
wherein said wireless transmission device further (i) stores a device identifier and audio setting information in association with each other, the device identifier being included in the wireless-connection-destination device information of the connection-destination device, and the audio setting information being information for setting an output condition of audio to be outputted from said audio output device, and (ii) transmits, when the connection-destination device is changed to a different connection-destination device, the audio setting information associated with the different connection-destination device to said audio output device, and
said audio output device sets, according to the received audio setting information, an output condition of audio to be outputted from said audio output device.

5. The wireless video and audio transmission system according to claim 4,
wherein the audio setting information is either sound volume control information for controlling sound volume or sound field control information for controlling a sound field.

6. The wireless video and audio transmission system according to claim 1,
wherein said audio output device:
judges whether or not the connection-destination device is capable of outputting audio, based on wireless-connection-destination device information obtained from the connection-destination device that is wirelessly connected via said wireless transmission device;
determines, when it is judged that the connection-destination device is capable of outputting audio, the audio mode of said audio output device to be the same as a previously determined audio mode; and
determines, when it is judged that said connection-destination device is not capable of outputting audio, the audio mode of said audio output device to be the audio output mode.

7. The wireless video and audio transmission system according to claim 1,
wherein said video output device:
judges, when (i) said video output device itself is selected to be the connection-destination device and (ii) said video output device judges that said video output device itself is not capable of outputting audio, whether or not said audio output device is capable of outputting audio, based on information obtained from said wireless transmission device, the information being information about a device connected to said wireless transmission device via a wired communication network; and
determines, when it is judged that said audio output device is capable of outputting audio, the audio mode of said audio output device to be the audio output mode, and instructs said audio output device to output audio.

8. The wireless transmission device included in the wireless video and audio transmission system according to claim 1, said wireless transmission device comprising:
a wired transmission unit configured to receive either the video and audio data or the video data, from either said audio output device or said video and audio reproducing device;
a wireless transmission unit configured to transmit a radio signal which includes the video and audio data, the video data, or audio data; and
a control unit configured to (i) judge whether or not the connection-destination device is capable of outputting audio, based on wireless-connection-destination device information obtained, through said wired transmission unit, from the connection-destination device that is wirelessly connected, (ii) determine, when it is judged that the connection-destination device is capable of outputting audio, the audio mode of said audio output device to be the same as a previously determined audio mode, and transmit the video and audio data to said connection-destination device through said wireless transmission unit, and (iii) determine, when it is judged that the connection-destination device is not capable of outputting audio, the audio mode of said audio output device to be the audio output mode, and transmit either the video data or the video and audio data to said connection-destination device through said wireless transmission unit.

9. The wireless transmission device according to claim 8, wherein said control unit is further configured to:
judge whether or not said audio output device is capable of outputting audio; and
wirelessly transmits, when it is judged that (i) said audio output device is not capable of outputting audio and (ii) the connection-destination device is not capable of outputting audio, either the audio data or the video and audio data to said video and audio output device so that said video and audio output device outputs audio.

10. The wireless transmission device according to claim 8, wherein said control unit is further configured to:
store a device identifier and audio setting information in association with each other, the device identifier being included in the wireless-connection-destination device information of the connection-destination device, and the audio setting information being information for setting an output condition of audio to be outputted from said audio output device; and
transmit, when the connection-destination device is changed to a different connection-destination device, the audio setting information associated with the different connection-destination device to said audio output device so that said audio output device sets, according to the audio setting information associated with the different connection-destination device, the output condition of audio to be outputted from said audio output device.

11. The wireless transmission device according to claim 10, wherein the audio setting information is either sound volume control information for controlling sound volume or sound field control information for controlling a sound field.

12. The audio output device included in the wireless video and audio transmission system according to claim 1, said audio output device comprising:
a first wired transmission unit configured to receive the video and audio data from said video and audio reproducing device;
a second wired transmission unit configured to transmit either the video and audio data received through said first wired transmission unit or video data that is included in the received video and audio data;
an audio output unit configured to reproduce audio data that is included in the video and audio data received through the first wired transmission unit, and either output or does not output audio depending on whether an audio mode of said audio output device is an audio output mode or an audio non-output mode; and
a control unit configured to (i) judge whether or not the connection-destination device is capable of outputting audio, based on wireless-connection-destination device information obtained from the connection-destination device that is wirelessly connected via said wireless transmission device, (ii) determine, when it is judged that the connection-destination device is capable of outputting audio, the audio mode of said audio output device to be the same as a previously determined audio mode, and transmit the video and audio data through said second wired transmission unit, and (iii) determine, when it is judged that the connection-destination device is not capable of outputting audio, the audio mode of said audio output device to be the audio output mode and transmit either the video data or the video and audio data through said second wired transmission unit.

13. The audio output device according to claim 12, wherein said wireless transmission device further (i) stores a device identifier and audio setting information in association with each other, the device identifier being included in the wireless-connection-destination device information of the connection-destination device, and the audio setting information being information for setting an output condition of audio to be outputted from said audio output device, and (ii) transmits, when the connection-destination device is changed to a different connection-destination device, the audio setting information associated with the different connection-destination device to said audio output device, and
said control unit is configured to set, according to the audio setting information received from said wireless transmission device, the output condition of audio to be outputted from said audio output device.

14. The audio output device according to claim 13, wherein the audio setting information is either sound volume control information for controlling sound volume or sound field control information for controlling a sound field.

15. The video output device included in the wireless video and audio transmission system according to claim 1, said video output device comprising:
a wireless transmission unit configured to receive the radio signal from said wireless transmission device through wireless connection;
a video output unit configured to output, as video, the video data that is included in the radio signal received through said wireless transmission unit; and
a control unit configured to (i) judge, when said video output device itself is selected to be the connection-destination device and when said control unit judges that said video output device itself is not capable of outputting audio, whether or not said audio output device is capable of outputting audio, based on information obtained from said wireless transmission device, the information being information about a device connected to said wireless transmission device via a wired communication network, and (ii) determine, when it is judged that said audio output device is capable of outputting audio, the audio mode of said audio output device to be the audio output mode, and instructs said audio output device to output audio.
